(19) United States
(12) Patent Application Publication
(10) Pub. No.: US 2018/0111554 A1
(43) Pub. Date: Apr. 26, 2018

(54) VEHICLE COMMUNICATION AND IMAGE PROJECTION SYSTEMS

(71) Applicant: Ford Global Technologies LLC, Dearborn, MI (US)

(72) Inventor: Anthony Pearce, Newport (AU)

(21) Appl. No.: 15/785,108

(22) Filed: Oct. 16, 2017

(30) Foreign Application Priority Data
Oct. 20, 2016 (CN) 201610916493.2

(51) Int. Cl. B60R 1/00; H04N 7/18; H04N 5/232; G08G 1/00; G08G 1/01; G08G 1/04; G08G 1/052; G08G 1/0967

(52) U.S. Cl. CPC B60R 1/00; G01S 19/42; H04N 5/23238; G08G 1/20; G08G 1/0112; G08G 1/04; G08G 1/052; G08G 1/096775; G08G 1/096791; B60R 2300/105; B60R 2300/102; B60R 2300/205; B60R 2300/303; B60R 2300/802; B60R 2300/8033; B60R 2300/8066; H04N 7/181

(57) ABSTRACT

A communication and image projection system in a vehicle of a fleet comprises an image sensor unit configured to capture images surrounding the vehicle; a processing unit configured to receive and process the images and an outside image captured by an outside vehicle; and a projection unit configured to receive the outside image from the processing unit and project the outside image to a surface viewable by an occupant of the vehicle.

### RELATED APPLICATION

This application claims the benefit of Chinese Patent Application No.: CN 201610916493.2 filed on Oct. 20, 2016, the entire contents thereof being incorporated herein by reference.

### FIELD

The present disclosure relates generally to vehicle communication and image projection systems, in particular, relates to vehicle communication and image projection systems to allow vehicle occupants to see other side of surrounding vehicles.

### BACKGROUND

With the development of automotive technology and telecommunication technology, vehicles can travel in close proximity to one another. For example, an autonomous vehicle in a fleet may travel bumper to bumper as a speed and a safe distance among the vehicles can be controlled. As a result, the occupants in some vehicles can only see the vehicles packed around and cannot see the other side of the surrounding vehicles. There exists a need to provide a system to open up the visual scene and reduce the perception of crowding for the occupants of the vehicle.

### SUMMARY

According to one aspect, a communication and image projection system in a vehicle of a fleet is provided. The communication and image projection system comprises an image sensor unit configured to capture images surrounding the vehicle; a processing unit configured to receive and process the images and an outside image captured by an outside vehicle; and a projection unit configured to receive the outside image from the processing unit and project the outside image to a surface viewable by an occupant of the vehicle.

In one embodiment, the image sensor unit may include cameras to capture the images in front, rear and sides of the vehicle or include a 360 degree camera.

In another embodiment, the surface may be a window of the vehicle, and wherein the window comprises material that is capable of display the image from the projection system.

In another embodiment, the window may include lens to enable display of a projected image.

In another embodiment, the window may include a transparent fluorescent screen that converts a projected image to corresponding visible emissive images.

In another embodiment, the surface may be an internal surface of the vehicle or a display or a screen in the vehicle.

In another embodiment, the surface may be an external surface of a surrounding vehicle of the vehicle.

In another embodiment, the communication and projection system may further include a GPS. The processing unit may communicate with a cloud server to receive and process additional information, transmit additional information to the projection unit and instruct the projection unit to project the additional information to the surface. Additional information may include at least one of a speed of the vehicle, a current location, direction of travel, time to the destination, road traffic conditions, safety warnings, speed sign alerts and advertising.

According to another aspect, a vehicle fleet comprises a first vehicle and a second vehicle travelling adjacent to the first vehicle. The first vehicle includes a first communication and projection system and a second vehicle includes a second communication and projection system. The first communication and projection system may include a first image sensor unit to capture first images surrounding the first vehicle; a first processing unit configured to receive the first images and a first outside image captured by an outside vehicle, and process the first image and the first outside image; and a first projection unit configured to receive and project the first outside image to a first surface viewable by an occupant of the first vehicle. The second communication and projection system may comprise a second image sensor unit configured to capture second images surrounding the second vehicle; a second processing unit configured to receive the second images and the first image, and process the first image and the second image; and a second projection unit configured to receive the first image from the second processing unit and project the first image including the outside view to a second surface viewable by an occupant of the second vehicle.

In one embodiment, the first and second communication and projection systems may include at least one of a GPS and a speed sensor, respectively. The first processing unit may be further configured to determine positions of the first and second vehicles according to the information from the GPS and the speed sensor, identify the first image including an outside view and transmit the first image including the outside view to the second vehicle. The second processing unit may be further configured to determine positions of the first and second vehicles according to the information from the GPS and the speed sensor, identify a second image including an outside view and transmit the second image including the outside view to the second vehicle. The first outside image received by the first vehicle may be the second image including the outside view; and the first image received by the second vehicle may be the first image including the outside view.

In another embodiment, the first surface may be a window of the first vehicle and the second surface may be a window of the second vehicle.

In another embodiment, the first surface may be an external surface of the second vehicle adjacent to the first vehicle and the second surface may be an external surface of the first vehicle adjacent to the second vehicle.

In another embodiment, the first and second vehicles may drive substantially in a row and the first vehicle may drive on a right side of the vehicle and adjacent to a side of a road and the second surface is a left side external surface of the first vehicle.

In another embodiment, the first vehicle may further include a visual marker on the left-side external surface and the first processing unit links the first image including the outside view with the visual marker. The second image sensor unit may capture the visual marker and transmit to the second processing unit. The second processing unit may be configured to identify a linked first image and the visual marker, and instruct the second projection unit to project the first image including the outside view on the second surface.

In another embodiment, the second processing unit may be configured to determine an orientation of a projection according to the visual marker. The visual marker may consist of one of the numbers, letters, a 2D barcode or a set of dots.

In another embodiment, the first vehicle may be a lead vehicle in a line and the second vehicle may be a second vehicle in the line. The second surface may be a back surface of the first vehicle, and the first image may have a view in front of the first vehicle and is projected on the back surface of the first vehicle by the second projection unit of the second vehicle.

In another embodiment, the fleet may include a third vehicle which is the third vehicle in the line. The third vehicle may include a third communication and projection system. The third communication and projection system may include a third image sensor unit configured to capture a third image surrounding the third vehicle; a third processing unit configured to receive the third image, a first image including an outside view and the second image, and processing the first image including the outside view, the second image and the third image; and a third projection unit configured to project the first image including the outside view to a back surface of the second vehicle. The first image including the outside view may be transmitted from the first processing unit to the third processing unit directly or transmitted from the first processing unit to the second processing unit and then transmitted from the second processing unit to the third processing unit.

In another embodiment, the first vehicle may be a last vehicle in a line and the second vehicle may be a second last vehicle in the line. The second surface may be a front surface of the first vehicle, and the first image may include a view behind the first vehicle and may be projected on the front surface of the first vehicle.

According to yet another aspect, a method of operating a communication and image projection system in a vehicle in a fleet is provided. The vehicle may include the communication and image projection system includes an image sensor unit, a processing unit and a projection unit. The method comprises receiving an outside image captured by an outside vehicle in the fleet; and projecting the outside image to a surface viewable by an occupant of the vehicle.

In one embodiment, the method may further comprise capturing images surrounding the vehicle by the image sensor unit; and processing the image by the processing unit and transmitting the image to another vehicle.

In another embodiment, the method may further comprise determining a position of the vehicle; identifying an image including an outside view; and transmitting the image including the outside view to the another vehicle.

In another embodiment, the surface viewable by the occupant of the vehicle may be a window of the vehicle.

In another embodiment, the surface viewable by the occupant of the vehicle may be an external surface of an adjacent vehicle.

In another embodiment, the processing unit may communicate with processing units of other vehicles in the fleet via a dedicated short range communication or a wifi or a cloud server.

The vehicle communication and image projection systems of the present disclosure are advantageous because they allow an occupant of the vehicle to see a view otherwise blocked by a surrounding vehicle.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a schematic plan view of a vehicle fleet on a road, illustrating an example of image transmission and projection between the vehicles having communication and image projection systems according to one embodiment of the present disclosure.

FIG. 2 is a schematic plan view of a vehicle fleet on a road, illustrating another example of transmission and projection between the vehicles according to the present disclosure.

FIG. 3 is a block diagram of a first and second communication and image projection systems in two vehicles.

FIG. 4 shows an embodiment of image transmission and projection between two vehicles.

FIG. 5 is a block diagram of a communication and image projection system in a vehicle according to another embodiment of the present disclosure.

FIG. 6 shows image projections on an interior of a vehicle having a communication and projection system illustrated in FIG. 5.

FIG. 7 is a flow chart illustrating a method of operating a communication and image projection system in a vehicle in a fleet in a vehicle in a fleet.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed communication and image projection systems in the vehicles will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various communication and image projection systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

An example communication and image projection systems of a vehicle of the present disclosure may include an image sensor unit to capture the images surround the vehicle, a processing unit configured to receive and process the image from the image sensor unit and images transmitted from other vehicles and related data, and a projection unit configured to project a selected image to a surface viewable by an occupant of the vehicle. In some embodiments, the surface may be a window of the vehicle. In some embodiments, the surface may be an external surface of a surrounding vehicle. The transmitted image may be the image captured by a vehicle traveling on a front, a lateral side and a back side of a fleet and facing an outside scenery. The image may be a video image reflecting real time view of the surrounding. In this way, an occupant can see the view which would otherwise be obstructed by the surrounding vehicles.

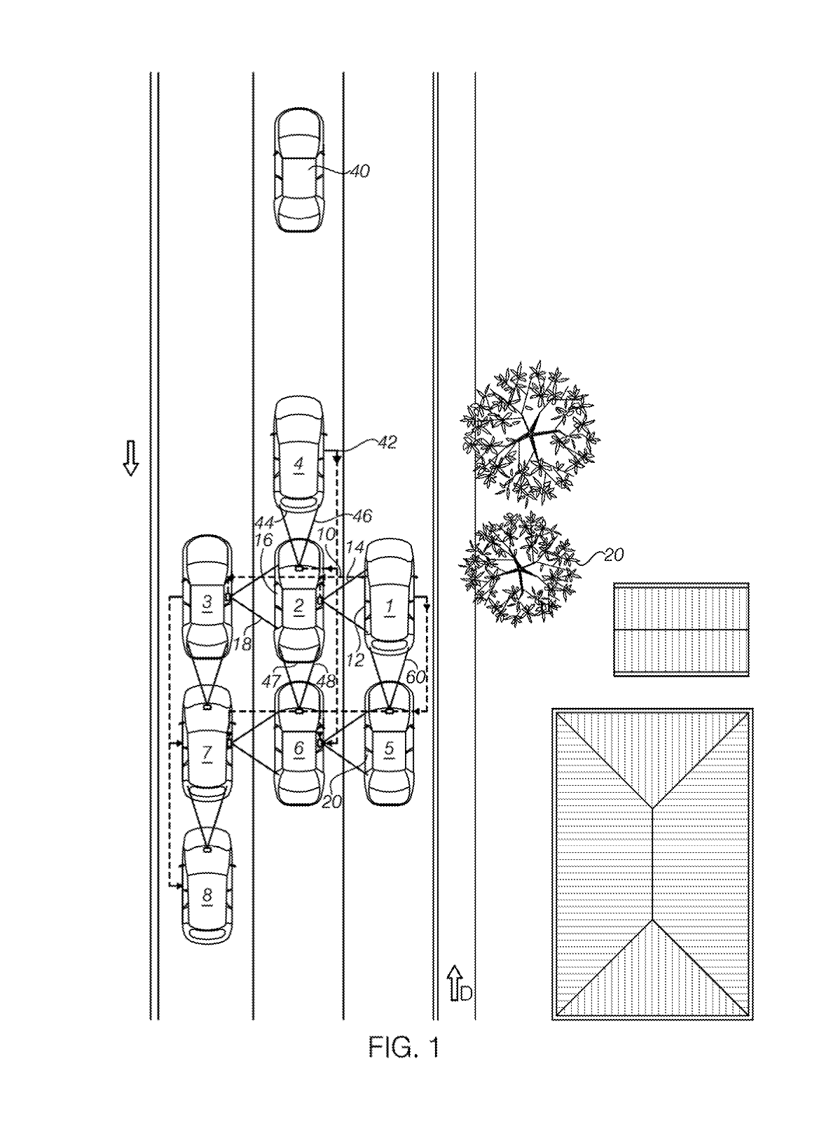

FIG. 1 is a schematic plan view of a vehicle fleet on a road, illustrating an example of transmission and projection of the images between the vehicles using an example vehicle communication and image projection system according to one embodiment of the present disclosure. In the present application, the fleet refers to a group of the vehicle travelling in close proximity or a group of vehicles under a central management. The vehicles may be any vehicles such as car, bus, airplane, and boat. The vehicles may be autonomous vehicles. FIG. 1 shows that the fleet travels in a direction D and a roadside scenery is on the right side of the fleet. Each vehicle in the fleet may include a communication and image projection system, which allows occupants in the vehicle to see an expanded view or a view blocked by other vehicles in the fleet. For example, an occupant of the vehicle 2 which is in the middle of the fleet may not see a right-side scenery on the right side of the fleet. However, the communication and projection system can receive and project the right-side image on a left external surface of vehicle 1 so that the occupant can see the roadside scenery as described in detail below. FIG. 1 illustrates transmission and projection of the images among vehicles travelling substantially in a row in the fleet. In FIG. 1, the image transmission path is illustrated with dash lines and the image projection path is illustrated with solid lines. As can be seen, vehicles 1, 2 and 3 travel substantially in a row and the vehicle 2 is surrounded by the vehicle 1 at its right side. A processing unit of the vehicle 2 may receive an image 20 captured from an image sensor unit of the vehicle 1. In the depicted example, the vehicle 1 is an outside vehicle of the fleet and also a surrounding vehicle of the vehicle 2. The surrounding vehicle is defined as a vehicle that is adjacent to or next to a vehicle. The image 20 may be transmitted via the transmission path 10 to the vehicle 2. A projection unit of the vehicle 2 may project the image 20 to an external surface 12 of the vehicle 1 via a projection path 14.

An occupant of the vehicle 3 may also see the roadside scenery using the vehicle communication and image projection system. For example, a processing unit of the vehicle 3 may receive the image 20 captured by the image sensor unit of the vehicle 1. In some embodiments, the image 20 may be transmitted directly from the vehicle 1 (i.e., the outside vehicle) via the transmission path 10. In some embodiments, the image 20 may be transmitted from the vehicle 1 to the vehicle 2 and then transmitted from the vehicle 2 (i.e., the surrounding vehicle of the vehicle 3) to the processing unit of the vehicle 3. That is, the image 20 may be relayed to the processing unit of the vehicle 3. A projection unit of the vehicle 3 may project the image 20 on an external surface 16 of the vehicle 2 via a projection path 18. In this way, the occupant of the vehicle 3 can see the right-side scenery by looking at the external surface 16 through a right window of the vehicle 3.

Similarly, an image captured by an image sensor unit of a vehicle 5 can be transmitted among the vehicles 5, 6 and 7 which are substantially in a row of the fleet and projected on an external surface of the vehicles 5 and 6.

With the similar principle, a scenery at left side of the road can be transmitted and projected. For example, a left-side scenery captured by vehicle 3 can be transmitted to the vehicle 2 and projected to a right external surface of the vehicle 3 so that an occupant the vehicle 2 can see the left-side scenery from a left window of the vehicle 2. Similarly, the left-side scenery captured by vehicle 3 can be further transmitted to the vehicle 1 and projected to a right external surface of the vehicle 2 so that an occupant of the vehicle 1 can see the left-side scenery from left window of the vehicle 1.

FIG. 1 further illustrates transmission and projection of an image of a front scenery among vehicles travelling in a line. An occupant of the vehicle 2 can see a scenery in front of the fleet using the communication and image projection system. For example, the vehicles 4, 2 and 6 are in the same line. A processing unit of the vehicle 2 may receive an image 40 captured from an image sensor unit of the vehicle 4. The image 40 is a front scenery captured by the image sensor unit of the vehicle 4. In the depicted example, the vehicle 4 is an outside vehicle of the fleet or a lead vehicle and also a surrounding vehicle of the vehicle 2. The image 40 may be transmitted via a transmission path 42 to a processing unit of the vehicle 2. A projection unit of the vehicle 2 may project the image 40 to a back external surface 44 of the vehicle 4 or a trunk portion of the vehicle 4 via a projection path 46.

An occupant of the vehicle 6 which is the last vehicle in the line can also see the front scenery using the communication and image projection system. For example, a processing unit of the vehicle 6 may receive the image 40. In some embodiments, the image 40 may be transmitted directly from the vehicle 4 (i.e., the lead vehicle or the outside vehicle) to the vehicle 6 via the transmission path 42. In some embodiments, the image 40 may be transmitted from the vehicle 4 to the vehicle 2 (i.e., the surrounding vehicle of the vehicle 6) and then transmitted from the vehicle 2 to the image processing unit of the vehicle 6. That is, the image 40 may be relayed to the processing unit of the vehicle 6. A projection unit of the vehicle 6 may project the image 40 on a back external surface 47 or a trunk portion of the vehicle 2 via a projection path 48. In this way, the occupant of the vehicle 6 can see the front scenery by looking at the external surface 47 through a front window of the vehicle 6.

Similarly, an image captured by an image sensor unit of a vehicle 3 can be transmitted among the vehicles 3, 7 and 8 which are substantially in a line of the fleet and projected on an external surface of the vehicles 3 and 7. An image captured by an image sensor unit of a vehicle 1 can be transmitted between the vehicles 1 and 5 which are substantially in a line of the fleet and projected on an external surface of the vehicle 1.

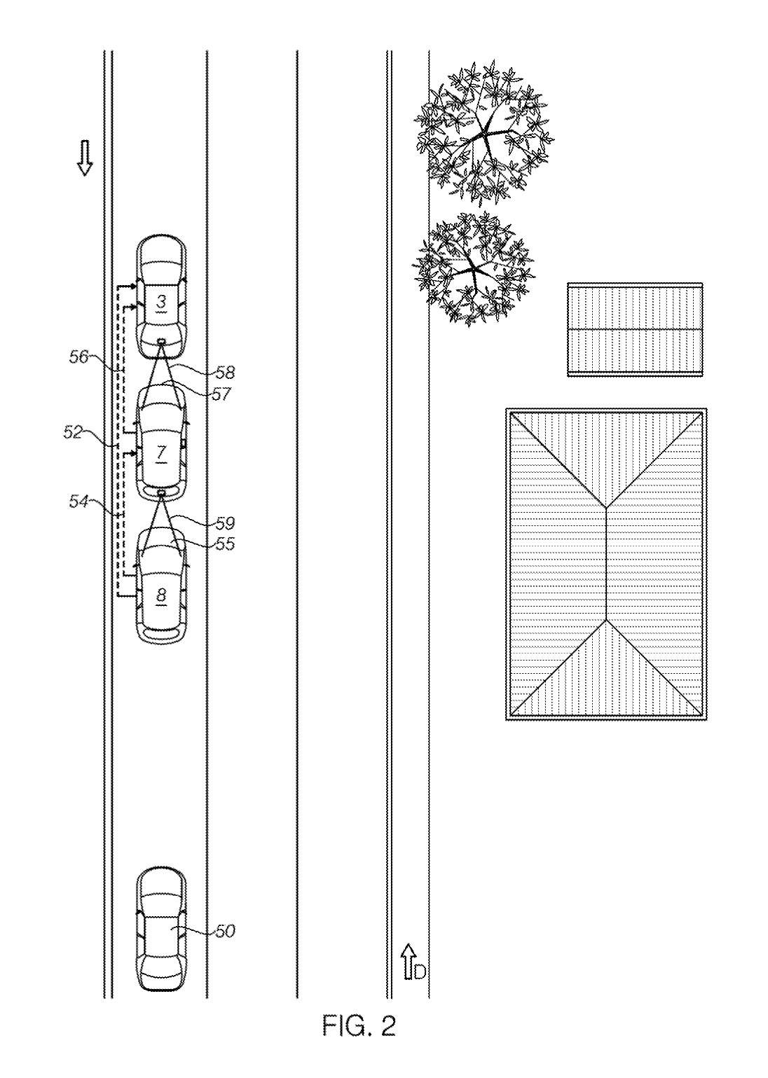

FIG. 2 is a schematic plan view of a vehicle fleet on a road, illustrating an example of transmission and projection of the mages captured by the last vehicle in a line according to one embodiment of the present disclosure. An occupant of the vehicle 3 (i.e., a lead vehicle in the line) can see a back scenery using the communication and image projection system. For example, a processing unit of the vehicle 8 may receive an image 50. In some embodiments, the image 50 may be transmitted directly from the vehicle 8 (i.e., the last vehicle or the outside vehicle) to the vehicle 3 via the transmission path 52. In some embodiments, the image 50 may be transmitted from the vehicle 8 to the vehicle 7 via a transmission path 54 and then transmitted from the vehicle 7 to the processing unit of the vehicle 3 via a transmission path 56. That is, the image 50 may be relayed to the processing unit of the vehicle 3. A projection unit of the vehicle 3 may project the image 50 on a front external surface 57 or a hood portion of the vehicle 7 via a projection path 58. In this way, the occupant of the vehicle 3 can see the back scenery by looking at the external surface 57 through a rear window of the vehicle 3. Similarly, a projection unit of the vehicle 7 may receive the image 50 via the transmission path 54 and project the image 50 on a front external surface 55 (i.e., a hood of the vehicle 8) via a projection path 59.

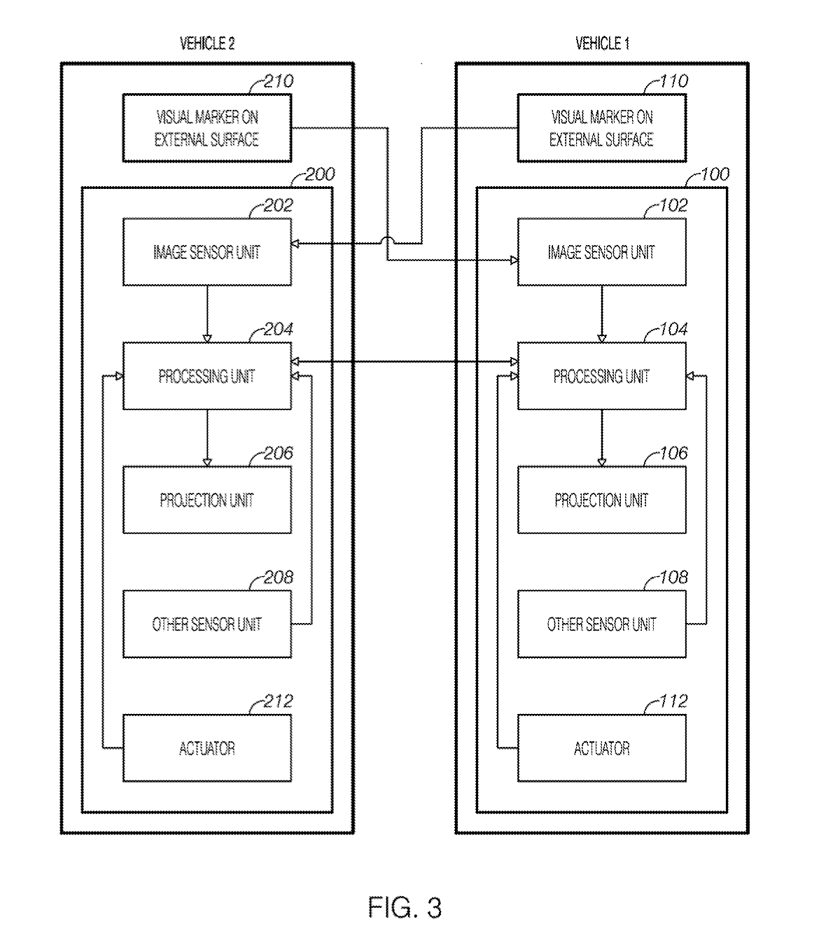

FIG. 3 is a block diagram of a first and second communication and image projection system 100 and 200 in a vehicle 1 and a vehicle 2, respectively, illustrating the communication between the vehicles 1 and 2. The vehicles 1 and 2 may be the vehicles adjacent to each other in a fleet. For example, the vehicles 1 and 2 may be the vehicles 1 and 2 illustrated in FIG. 1 in which the vehicles 1 and 2 travel side by side and vehicle 1 travels near one side of a road. It should be appreciated that the communication and projection described below may apply to the vehicles travel in different position in the fleet. For example, the vehicles 1 and 2 may travel in the same line and the vehicle 1 is in front of the vehicle 2. In another example, the vehicles 1 and 2 travel in the same line and the vehicle 1 is in rear of the vehicle 2. The communication and image projection system 100 of vehicle 1 may include a first image sensor unit 102, a first processing unit 104 and a first projection unit 106. Additionally or alternatively, the vehicle communication and image projection system 100 may include other sensor unit 108 which may include a GPS and/or speed sensor for example. Similarly, the communication and image projection system 200 of vehicle 2 may include a second image sensor unit 202, a second processing unit 204, a second projection unit 206 and/or other sensor units 208. The communication and image projection systems 100 and 200 may be similar. For the sake of brevity, the first image sensor unit 102, the first image processing unit 104 and the first projection unit 106 of the communication and image projection systems 100 are described in detail here.

The first image sensor unit 102 may be configured to capture first images surrounding the vehicle 1. The first images may include views in front, lateral and back sides of the vehicle 1. The first image sensor unit 102 may be any suitable image sensor unit that is capable of capturing a front image, a left image, a right side image and a rear image of the vehicle 1. For example, the first image sensor unit 102 may include a plurality of cameras disposed at different places of the vehicle 1 or a plurality of cameras disposed at one place of the vehicle. In another example, the first image sensor unit 102 may be a 360 degree camera that can capture the images around the vehicle 1 and the 360 degree camera may be disposed at one place of the vehicle 1 such as on a roof of the vehicle 1. In yet another example, the first image sensor unit 102 may include a night vision camera which can capture a better image in the night. The first image sensor 102 may be a video camera that captures live streams of the images. In some embodiments, the vehicle 1 is an autonomous vehicle and the image sensor unit may be a camera system used for in a system for controlling the driving of the vehicle. The image captured by the first image sensor may include a visual marker 210 disposed on an external surface of vehicle 2.

The first processing unit 104 may be configured to receive and process the image and data. The first processing unit 104 may include a processor that provides for computational resources. The first processing unit 104 may serve to execute instructions for software that may be loaded into a memory unit. The instructions may include program code, computer-usable program code, or computer-readable program code. The memory unit may be a storage device that is capable of storing information, such as, without limitation, data, program code in functional form, and/or other suitable information on either a temporary basis and/or a permanent basis. For example, the memory unit may include a random access memory or any other suitable volatile or non-volatile storage device and a persistent storage. The persistent storage may be one or more devices such as a hard drive, a flash memory, a rewritable optical disk, a rewritable magnetic tape, or some combination of the above.

In some embodiments, the first processing unit 104 may be configured to receive the first images from the first image sensor unit 102, and a first outside image captured from an outside vehicle of the fleet. Additionally or alternatively, the first processing unit 104 may receive other information/data related to the images transmitted among the vehicles. In one example, the first outside image is the outside image captured by an image sensor unit 202 of the vehicle 2, and the other information includes a visual marker 210 of the vehicle 2. The first processing unit 104 may further process the first images for the transmission to other vehicles. In some embodiments, the first processing unit 104 may identify the first image including an outside view and transmit the first image including an outside view to other vehicles.

In some embodiments, the first processing unit 104 may determine a position of the vehicle 1 in the fleet from the images surrounding the vehicle 1. If the front image shows an open space or the vehicle travelling at a certain distance away from the vehicle 1, a right side image shows a scenery, a left side image shows a vehicle closed by and a rear image shows a vehicle closed behind, the image processing unit 102 may determine that the vehicle 1 is a lead vehicle in a line and also an outside vehicle of the fleet as illustrated in FIG. 1.

Upon determination of the vehicle position, the first processing unit 104 may process the first images and determine the first images to be transmitted to the other vehicles. In the example in FIG. 1, the processing unit 104 may transmit the images with right scenery to the vehicle 2 and the first images having the front view to the vehicle behind the vehicle (e.g., the vehicle 6 in FIG. 1).

In other embodiments, the first processing unit may transmit the first images to another vehicle without identifying the first image including the outside view. A processing unit of another vehicle may process the first images and determine the first images including the outside view and transmit to a projection unit for projection.

The first image processing unit 104 may further process a first outside image captured from an outside vehicle of the fleet. The first outside image may include the image that cannot be seen by an occupant of the vehicle 1. For example, the first outside image may include an image captured by an outside vehicle at a left side of the fleet, which may be a view of oncoming vehicle flow (i.e., the flow in a direction opposite the direct of the fleet) or a scenery at the left side road. If the vehicle 2 is the outside vehicle traveling on the left side of the vehicle 1, the first outside image may be an image captured by the image sensor unit 202 of the vehicle 2 and is transmitted from the processing unit 204 of the vehicle 2 to the first processing unit 104 of the vehicle 1.

The first processing unit 104 may process additional information before instructing the first projection unit 106 to project the first outside image to an external surface of the vehicle 2. In some embodiments, the vehicles may include a visual marker disposed on their external surfaces. For example, the vehicle 2 may include a visual marker 210 having a bar code or other signals. A processing unit 204 of the vehicle 2 may link the visual marker 210 with the image to be transmitted to the vehicle 1. The first processing unit 104 may analyze the image of the visual marker 210 captured from the first image sensor unit and the linked image from the second processing unit 204 to determine a surface to project the linked image. The first processing unit 104 may further determine the projection orientation according to the location of the visual mark and positions and velocities of the vehicles 1 and 2.

In some embodiments, all images captured by a vehicle may be broadcast to the rest of the vehicles in the fleet and each broadcast image is accompanied with the associated data. The processing unit of the receiving vehicle may select the best image for projection from the broadcast images according to the associated data. In one example, the selection may be made by detecting a linked visual marker, or by GPS or other position data accompanying the broadcast images. In another example, the associated data transmitted with the image may include an indication on an origin of the image, e.g., whether the image is an outside image. The processing unit of the receiving unit may decide which image to project based on the associated data. For example, the vehicle 2 in FIG. 1 may have available image data from all other vehicles 1, 3, 4, 5, 6, 7, 8 and may select the best or most appropriate image to project on each available surrounding surface according to the associated data.

In some embodiments, the external surface of the vehicle 2 may include a plurality of symbols to define an area to project the first image including the outside view to exclude a side window of the vehicle 2. Based on a shape formed by the symbols, the processing unit 104 may determine the projection area. In some embodiments, the second processing unit 204 may transmit information on a type of vehicles so that the processing unit 104 can determine the projection area excluding the window according to the vehicle type information.

The first projection unit 106 may receive and project the first images or the first image including the outside view. The first projection unit 106 may be any suitable projection unit capable of projecting a representation of the scenery on the surface such as a video projector, LED projector, or laser projector. The projection unit 106 may include a plurality of projection devices. In some embodiments, the projection devices may be disposed on a front, two lateral and rear sides of the vehicle 1. In some embodiments, the projection unit 106 may be a single unit integrated with a plurality of projection device and the projection unit 106 may be disposed on a roof of the vehicle 1. In the example illustrated in FIG. 1, the first outside image including a left-side scenery of the vehicle 2 may be projected on a right external surface of the vehicle 2 so that the occupant in the vehicle 1 can see the outside scenery blocked by the vehicle 2 when the occupant looks through a left window of the vehicle 1.

The first communication and image projection system 100 may further include other sensors to facilitate the transmission and projection. In one example, the other sensors may include a Global Positioning System (GPS) or other suitable local positioning system. The GPS may communicate with the first processing unit 104 to confirm the position of vehicle 1 in the fleet. The GPS may further provide information on the oncoming traffic vehicle so that the vehicle 1 does not project the images to an adjacent incoming vehicle. The other sensor units 108 may include a speed sensor that detects the speed of the vehicle 1. The first processor unit 104 may estimate the relative speed of the vehicles 1 and 2 by comparing the speed of the vehicle 1 and the speed of the vehicle 2 received from the second processing unit 204 and determine whether the adjacent vehicle is driving in the same direction or in the opposite direction. Further, the first processing unit 104 may adjust the projection angle according to the position and relative speed between the vehicle 1 and the vehicle 2.

The first communication and image projection system 100 may further include a projection actuator 110 electrically connected with the first processing unit 104. The occupant may choose whether or not to see the outside view by activating the projection actuator 110. The projection actuator 110 may be disposed adjacent to the window and may include a plurality of buttons for a left view, a right view, a front view and a rear view to control the projection of these views on the corresponding surface.

The first processing unit 104 may further communicate with a cloud server of the vehicle 1 or the fleet, and/or a third-party cloud server that provides third party content. In this way, the first projection unit 106 may project additional information including but not limited to the speed of the vehicle 1, the current location, time to the destination, the road traffic conditions, safety warnings, speed sign alerts, and advertising. The additional information may further include visual pointers recognized by the vehicle 1 or other vehicles. The visual pointers may be projected on the external surface of the vehicle to differentiate the projected image from an unobstructed view of the scenery.

Now turning to the second communication and image projection system 200 of the vehicle 2, the system 200 may include a second image sensor unit 202, a second processing unit 204 and a second projection unit 206 and/or other sensor unit 208. The second image sensor unit 202 may be configured to capture a second image surrounding the vehicle 2 and transmit the second image to the second processing unit 204. The second processing unit 204 may receive the second image from the image sensor unit 202 and the first images transmitted from the processing unit 104. The second processing unit 204 may process the second images and the first images as described above and transmit the first images including the outside view to the second projection unit 206 and transmit the second image to the processing unit 104 of the vehicle 1 and/or other vehicles. In the example illustrated in FIG. 1, the first image may be projected on a left external surface of the vehicle 1 so that an occupant of the vehicle 2 can see the right-side scenery.

Similar to the vehicle 1, the communication and projection system 200 of the vehicle 2 may include a projection actuator 210 and may communicate with a cloud server or a third-party server.

It should be appreciated that the vehicle 1 and vehicle 2 may be at the positions in the fleet different from those described above. For example, the vehicle 1 and vehicle 2 may be in the same line of the fleet. However, the principles described above for the communication and the projection between the vehicles may apply.

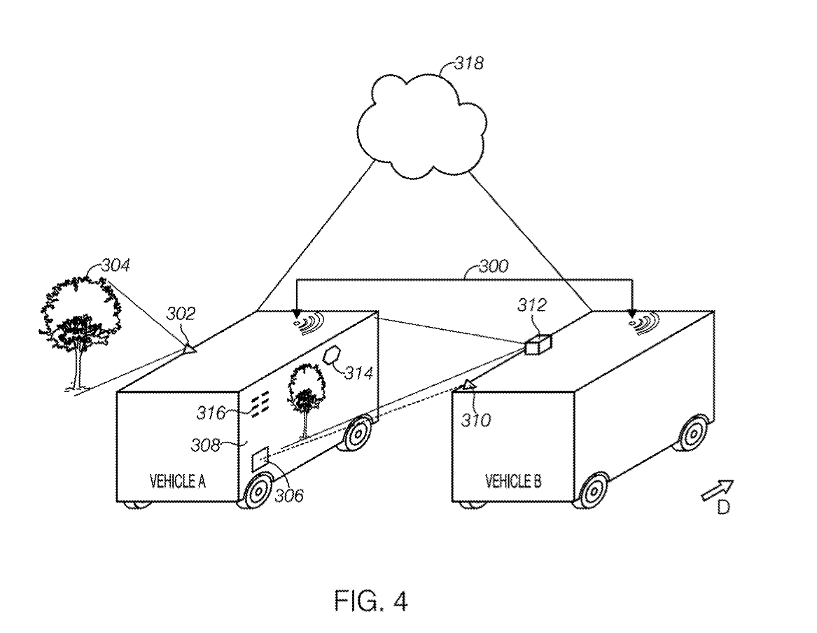

FIG. 4 schematically shows an embodiment of image transmission and projection between the vehicle A and vehicle B. In the illustrated example, the vehicle A and the vehicle B travel in the adjacent lines in a direction D. The vehicles A and B include the communication and projection system as described above. In some embodiments, the vehicles A and B may communicate via a dedicated short range communication, Wifi, radio or any suitable vehicle to vehicle communication protocols. The communication may be performed between processing units in the vehicles A and B. For example, the signal 300 including images or data may be transmitted between the vehicles A and B. As can be seen in FIG. 4, an image sensor unit 302 of the vehicle A captures an image 304 on a left-side road. The processing unit of the vehicle A may link the image 304 to a visual marker 306 which is disposed on an external surface 308 of the vehicle A. The visual marker 306 may be numbers and/or letters, a 2D barcode or set of dots. A linked image 304 may include an identifier associated with the visual marker 306. An image sensor unit 310 of the vehicle B may capture the visual marker 306 and transmit it to a processing unit of the vehicle B. The processing unit of the vehicle B may determine an image to be projected among the images received from a plurality of vehicles. In the depicted example, the processing unit of the vehicle B may compare the received images and the visual marker 306, and select the image 304 linked to the visual marker 306 as the image to be projected when it is determined that the identifier in the linked image 304 matches the visual marker 306. The processing unit of the vehicle B may further instruct a projection unit 312 to project the image 304 to the external surface 308.

In some embodiments, the vehicle B may project a visual pointer 314 along with the image 304. The visual pointer 314 may be used to identify the image 304 projected on the external surface 308 as a captured image so that a driving system of the vehicle B knows that there is a vehicle on its left side rather than the scenery and controls the driving accordingly.

In some embodiments, the vehicles A and B may communicate via a cloud server. For example, both vehicles A and B may be connected to the cloud server 318 to which they subscribe. The server 318 may provide additional projection information including but not limited to traffic condition, speed sign alerts, safety warnings, and/or other third-party content (e.g., advertising). The vehicle B may further project the additional information 316 to the external surface 308.

In some embodiments, the communication and projection system of the vehicle B may compare the image 304 with other vehicles' data transmissions continuously to confirm that the vehicle A is still the closest vehicle to project the image. Additionally or alternatively, the communication and projection system of the vehicle B may compare data from the GPS and determines its position relative to that of the vehicle A. If the communication and projection system of the vehicle B determines that the vehicle A is no longer the closest vehicle to the vehicle B (e.g., the vehicle A travels further in front or behind the vehicle B), the vehicle B turns off the transmission. If the communication and projection system of the vehicle B determines that the vehicle B is the closest vehicle and no other vehicle is projecting, it will turn on the projection unit 312. A delay/hysteresis may be configured between on and off events to prevent frequent switching.

In some embodiments, all images captured by the vehicle A may be broadcast to the vehicle B along with the associated data with each image. The processing unit of the vehicle B may select the best image for projection from the broadcast images according to the associated data. The associated data may be a visual marker on an external surface of the vehicle B or other position data indicating an origin of the images (e.g., left, right, front or rear images). In the depicted example, the linked image with the visual marker information distinguishes other images such as the images including a front view, a rear view and a right view of the vehicle A. In this way, the processing unit of the vehicle B can select the image 304 to projected on the external surface 308.

In some embodiments, the vehicles A and B may continually receive images and project images as they are travelling. In some embodiments, the projection may be activated by an occupant of the vehicles via an actuator connected to the communication and projection system.

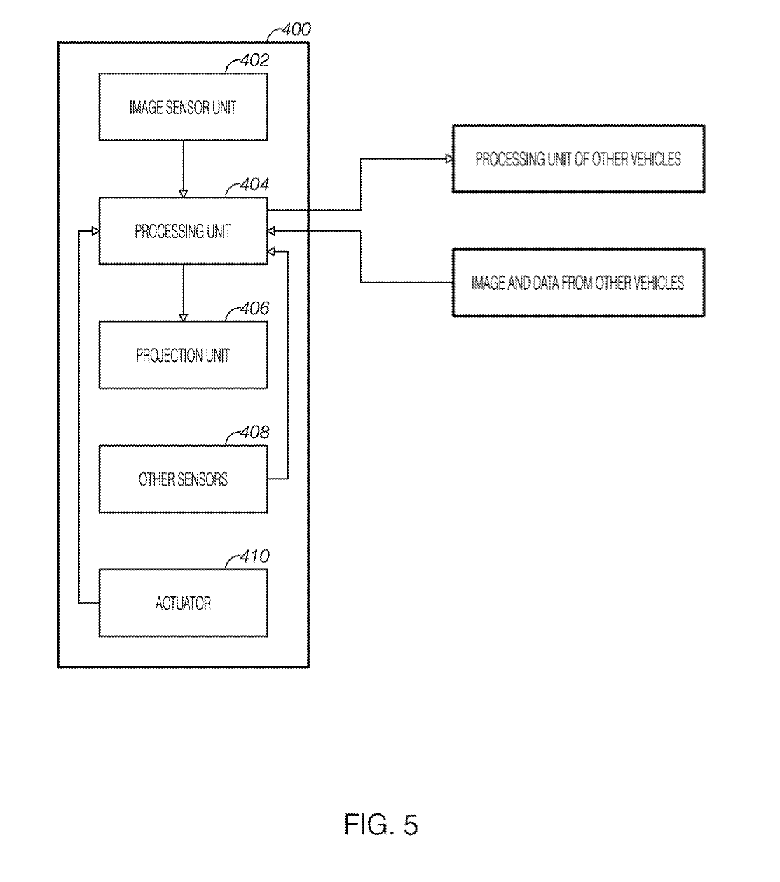

FIG. 5 is a block diagram of a communication and image projection system 400 in a vehicle according to another embodiment of the present disclosure. The communication and image projection system 400 is configured to project an image to an internal surface of the vehicle. The vehicle may travel in close proximity with other vehicles in a fleet. The other vehicle may include a communication and projection system similar to the communication and image projection system 400. The communication and image projection system 400 may include an image sensor unit 402, a processing unit 404, a projection unit 406, and other sensors 408 which may include a GPS and/or a speed sensor. The image sensor unit 402 may capture images surrounding the vehicle and transmit the images to the processing unit 404. The processing unit 404 may receive the images from the image sensor unit 402, and an outside image and/data from processing unit of other vehicles. The outside image may be projected on an internal surface of the vehicle.

In some embodiments, the images may be projected in left, right, front and rear windows of the vehicle by the projection unit 406. The processing unit 404 may determine the images to be projected and the windows to project the images. In some embodiments, the processing unit 404 may determine whether the outside image is on left, right, front and back sides of the vehicle by examining the outside image. For example, a scenery moving toward the back of the vehicle and including a road side scenery may indicate a left scenery or a right side scenery. An image including the lines on the road may indicate a front or back scenery. In some embodiments, the processing unit 404 may receive information from the other sensors 408 such as GPS, which may notify a position of the vehicle in the fleet. Similarly, an outside vehicle may know its position in the fleet from the GPS and transmit the outside image along with the position data to the vehicle. Upon the determination of the origin where the outside image is captured, the image processing unit 404 may instruct the projection unit 406 to project the image to the specific window. The projection unit 406 may include front window, side window and rear window projectors which receive and project the images showing front, side and rear views of the fleet, respectively. In some embodiments, all images captured by other vehicles in the fleet may be broadcast to the vehicle and each incoming image is accompanied with the associated data. The processing unit 404 may select the best image for projection from the broadcast images according to the associated data. In one example, the associated data may be associated with a code of a camera or a field of view of a camera that captures a specific image so that the processing unit 404 knows the image is a front, a rear or sides view, for example. In another example, the associated data may include GPS data or other position data to identify the image, e.g., whether the image is an outside image, or the view on the other side of surrounding vehicle or whether the image is a left, right or side view. It should be appreciated that the associated data may be any suitable data that identify the image transmitted to the vehicle.

Any suitable vehicle to vehicle communication protocol may be used for the image transmission. Additional information may be transmitted along with the outside images to the processing unit 404 of the vehicle. For example, the speed and position of other vehicles may be communicated to the processing unit 404. By comparing the speed and position of the vehicle with those of other vehicles, the processing unit 404 can select the outside images that reflect the real time scenarios seen by the vehicle if not blocked by the surrounding vehicles and instruct the projection unit 406 to project the outside image on a specific surface.

The vehicle may communicate with a cloud server of the vehicle and/or a third-party cloud server that provides third party content. The projection unit 406 may project additional information including but not limited to the speed of the vehicle, the current location, time to the destination, the road traffic conditions, safety warnings, speed sign alerts, and advertising.

The window of the vehicle may be made of any suitable material that is capable of displaying the projected images. In some embodiments, the window may include a lens to enable display of a projected image. In some embodiments, the window may include a transparent fluorescent screen that converts a projected image to corresponding visible emissive images.

In some embodiments, the outside images may be displayed on a display or a screen inside the vehicle. In some embodiments, the images may be displayed on a display or a screen outside the vehicle.

In some embodiments, the images may continue projecting on the windows of the vehicle so that the occupant has an expanded view of scenery even though the view is blocked by the vehicle traveling nearby.

In some embodiments, the projection may be activated by an occupant. The communication and image projection system 400 may further include a projection actuator 410. The actuator 410 may be located on a frame of the window to allow the occupant to choose if he or she wants to see the views blocked by other vehicles. The actuator 410 may allow the occupant to select the view to be projected on the windows. For example, the occupant may select a left outside view to be projected on the left window, a right outside view to be projected on the right window, a rear outside view to be projected on the rear window, and/or a front outside view to be projected on the front window. The selected view may satisfy the occupant's need while saving energy comparing to project the images on all window.

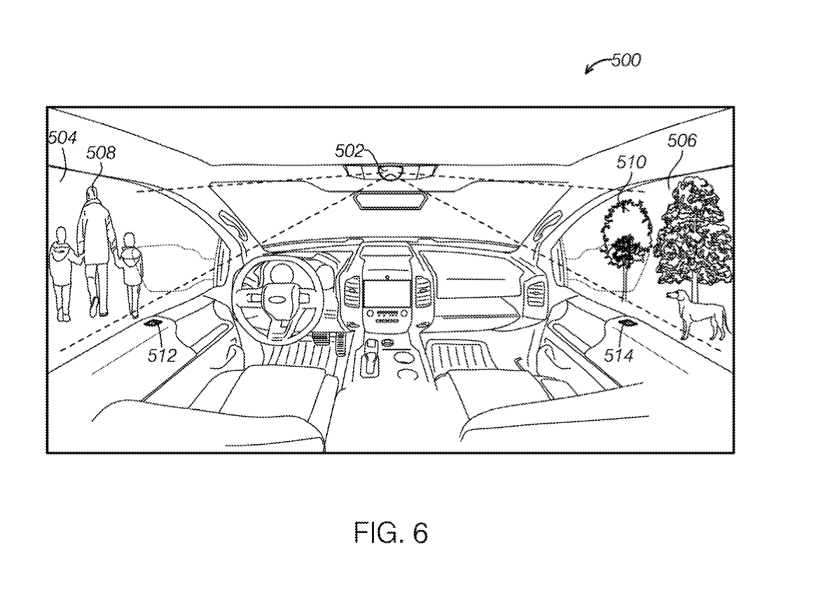

FIG. 6 shows image projections on an interior of a vehicle 500 having a communication and projection system similar to the system 400 illustrated in FIG. 5. The vehicle 500 may travel in a fleet. In the depicted example, the vehicle 500 may include a projection unit 502 configured to project the images at least on a left window 504 and a right window 506. As can be seen, an image 508 showing a scenery at a left side of the road is projected on the left window 504. An image 510 showing a scenery on a right side of the road is projected on the right window 506.

In some embodiments, an actuator 512 may be disposed adjacent to the left window 504. An occupant sitting by the left window 504 may turn on the communication and projection system using the actuator 512 if he or she wants to see a view blocked by a vehicle travelling on the left side of the vehicle. Similarly, an actuator 514 may be disposed adjacent to the right window 506. An occupant sitting by the right window 504 may turn on communication and projection system using the actuator 514 if he or she wants to see a view blocked by a vehicle travelling on the right side of the vehicle.

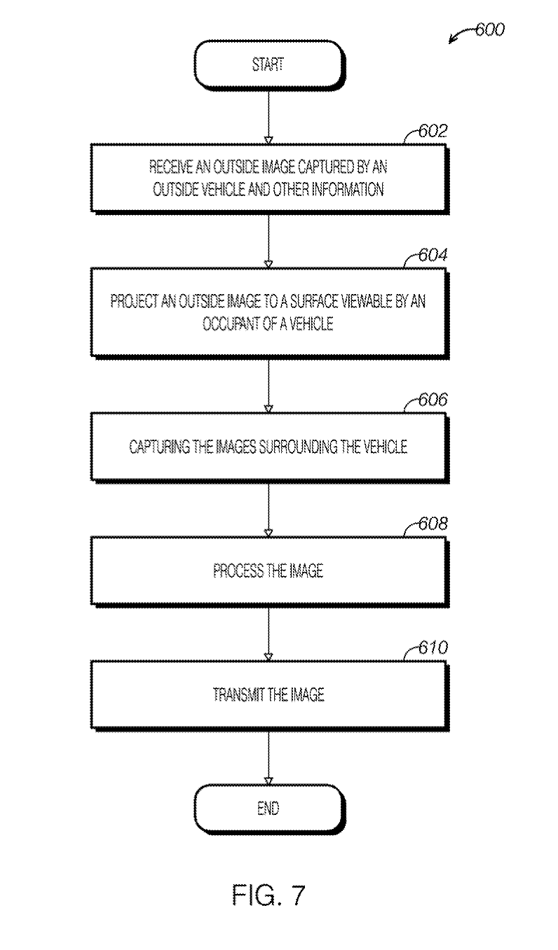

FIG. 7 is a flow chart illustrating a method 600 of operating a communication and image projection system in a vehicle in a fleet. The communication and projection system may include an image sensor unit, an image processing unit and a projection unit as described above with reference to FIG. 3 and FIG. 5. The communication and projection system of the vehicle may communicate with the communication and projection systems of other vehicles. At 602, method 600 may include receiving an outside image captured by an outside vehicle and other information related to the image projection. The outside vehicle may be a vehicle travelling at outside of the fleet. The outside vehicle may be a lead vehicle or a rear vehicle travelling in the same line as the vehicle or a left outside or right outside vehicle travelling substantially in the same row as the vehicle.

At 604, method may include projecting the outside image to a surface viewable by an occupant of the vehicle. The processing unit of the vehicle may process the outside image, determine the surface to project the outside image and instruct the projection unit to project the outside image. In some embodiments, the processing unit of the vehicle may determine an origin of the outside image (i.e., a front view, a rear view, a left side or a right view) according to the view in the outside image and/or other information such as positions of the outside vehicle. Alternatively or additionally, the outside image received by the processing unit is processed by the outside vehicle and the other information transmitted with the outside image includes associated data to identify the origin of the outside image. In some embodiments, all images captured by other vehicles in the fleet may be broadcast to the vehicle and each image is accompanied with the associated data. The processing unit of the vehicle can determine a best image or the outside image to be projected according to the associated data.

The projection unit receives the instruction from the processing unit and projects the outside image to the corresponding side of the vehicle. In some embodiments, the surface viewable by the occupant of the vehicle may be a window of the vehicle. In some embodiments, the surface viewable by the occupant of the vehicle may be an external surface of an adjacent vehicle. The images including the views in front, right side, left side, and rear side of the vehicle may be projected on the surfaces in front, right, left and rear of the vehicle, respectively. The images including the views above and below of the vehicle may be projected onto an interior roof or a floor of the vehicle, respectively. The image below the vehicle may provide a view of the ground terrain ahead, for example. The image above the vehicle may provide an upper view or a scenery that is of interest to the occupant. The image to be projected may be selected manually through the actuator or automatically by the system.

While the vehicle receives the outside image, the vehicle may capture images surround the vehicle, processing and transmitting the image to another vehicle. At 606, method 600 may include capturing images surrounding the vehicle by an image sensor unit. The images may include views in front, right side, left side, rear side, above and below of the vehicle. Next, at 608, method 600 may process the image by the processing unit. In some embodiments, method 600 may include determining a position of the vehicle in the fleet and identify an image including an outside view. In some embodiments, the vehicle position in the fleet may be determined according to the images surrounding the vehicle. For example, method 600 may determine that the vehicle is a lead vehicle at a line and surrounded by other vehicles if the front view shows a street ahead and the left, right and rear views show the vehicles traveling nearby in the same direction. In this example, method 600 may determine that the images include an outside view, i.e., a front view. It should be appreciated that the vehicle position in the fleet may be determined by any suitable approaches such as a GPS or a cloud server of the fleet or via the vehicle to vehicle communication. In some embodiments, the processing unit may associate the captured images with data or code to enable the processing unit of the receiving vehicles to select the image to project to an appropriate surface.

Next, at 610, method 600 may include transmitting the image to at least another vehicle in the fleet. In some embodiments, the transmitted image may include the image with associated data and/or other information related to the image. For example, the associated data may identify the origin of the image, i.e., a front, a rear, a left or a right scenery of the fleet or identify a position of the vehicle in the fleet. In some embodiments, the method 600 may transmit all images captured by the vehicle to other vehicles. In some embodiments, method 600 may transmit selected images (e.g., outside images) to selected vehicles. For example, method 600 may transmit the image to other vehicles travelling substantially in a same row or a same line of the vehicle. For example, if it is determined that the vehicle is a lead vehicle, the images including the outside image is a front image captured by the image sensor unit of the vehicle. The image may be transmitted to the vehicles traveling in the same line and behind the vehicle as described in FIG. 1. In another example, if the vehicle is a vehicle on right outside of the fleet, the images including the outside image further include a right scenery captured by the image processing unit of the vehicle. The image is transmitted to the vehicles travelling substantially at the same row of the vehicles and on the left side of the vehicle.

The method described above enables an occupant to see the views otherwise blocked by an adjacent vehicle by looking at the surface with the projected image.

It should be appreciated while the projected image is described as an outside image, the projected image can be an image showing the traffic on the other side of the nearest vehicle. An occupant may choose to see the outside image or the image showing the traffic on the other side of the nearest vehicle by activating the actuator.

Note that the example control and estimation routines included herein can be used with various vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the control system.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A communication and image projection system in a vehicle of a fleet, comprising:
an image sensor unit configured to capture images surrounding the vehicle;
a processing unit configured to receive and process the images and an outside image captured by an outside vehicle; and
a projection unit configured to receive the outside image from the processing unit and project the outside image to a surface viewable by an occupant of the vehicle.

2. The communication and image projection system of claim 1, wherein the image sensor unit includes cameras to capture the images in a front, a rear side, a left side, and a right side of the vehicle or the images above and below the vehicle or the image sensor unit includes a 360 degree camera.

3. The communication and image projection system of claim 1, wherein the surface is a window of the vehicle, and wherein the window comprises material that is capable of display the image from the projection system.

4. The communication and image projection system of claim 3, wherein the window includes lens to enable display of a projected image.

5. The communication and image projection system of claim 3, wherein the window includes a transparent fluorescent screen that converts a projected image to corresponding visible emissive images.

6. The communication and image projection system of claim 1, wherein the surface is an internal surface of the vehicle or a display or a screen in the vehicle.

7. The communication and image projection system of claim 1, wherein the surface is an external surface of a surrounding vehicle of the vehicle, or a display or a screen on the vehicle exterior.

8. The communication and image projection system of claim 1, further comprising a GPS, wherein the processing unit is communicated with a cloud server, wherein the processing unit is configured to receive and process additional information and instruct the projection unit to project the additional information to the surface, wherein the additional information includes at least one of a speed of the vehicle, a direction of travel, a current location, time to the destination, road traffic conditions, safety warnings, speed sign alerts, and, advertising

9. A vehicle fleet, comprising:
a first vehicle including a first communication and projection system, comprising:
a first image sensor unit to capture first images surrounding the first vehicle;
a first processing unit configured to receive the first images and a first outside image captured by an outside vehicle, and process the first images and the first outside image; and
a first projection unit configured to receive and project the first outside image to a first surface viewable by an occupant of the first vehicle;
a second vehicle adjacent to the first vehicle and including a second communication and projection system, the second communication and projection system comprising:
a second image sensor unit configured to capture a second image surrounding the second vehicle;
a second processing unit configured to receive the second image and the first image, and process the first image and the second image;
a second projection unit configured to receive the first image from the second processing unit and project the first image including an outside view to a second surface viewable by an occupant of the second vehicle.

10. The vehicle fleet of claim 9, wherein the first and second communication and projection systems include at least one of a GPS and a speed sensor, respectively; wherein the first processing unit is further configured to determine positions of the first and second vehicles according to the information from the GPS and the speed sensor, identify the first image including the outside view and transmit the first image including the outside view to the second vehicle; wherein the second processing unit is further configured to determine positions of the first and second vehicles according to the information from the GPS and the speed sensor, identify a second image including an outside view and transmit the second image including the outside view to the first vehicle, and wherein the first outside image received by the first vehicle is the second image including the outside view; and the first image received by the second vehicle is the first image including the outside view.

11. The vehicle fleet of claim 9, wherein the first surface is a window of the first vehicle and the second surface is a window of the second vehicle.

12. The vehicle fleet of claim 9, wherein the first surface is an external surface of the second vehicle adjacent to the first vehicle and the second surface is an external surface of the first vehicle adjacent to the second vehicle.

13. The vehicle fleet of claim 12, wherein the first and second vehicles drive substantially in a row and the first vehicle drives on a right side of the second vehicle and is adjacent to a side of a road, wherein the second surface is a left side external surface of the first vehicle, the first vehicle further includes a visual marker on the left-side external surface and the first processing unit links the first image including the outside view with the visual marker, wherein the second image sensor unit captures the visual marker and transmit to the second processing unit, wherein the second processing unit is configured to identify a linked first image and the visual marker, and instruct the second projection unit to project the first image including the outside view on the second surface.

14. The vehicle fleet of claim 12, wherein the first vehicle is a lead vehicle in a line and the second vehicle is a second vehicle in the line, and wherein the first image has a view in front of the first vehicle and is projected on a back surface of the first vehicle by the second projection unit of the second vehicle.

15. The vehicle fleet of claim 14, further comprising a third vehicle which is the third vehicle in the line, the third vehicle including a third communication and projection system comprising:
a third image sensor unit configured to capture a third image surrounding the third vehicle;
a third processing unit configured to receive the third image, a first image including an outside view and the second image, and processing the first image including the outside view, the second image and the third image; and
a third projection unit configured to project the first image including the outside view to a back surface of the second vehicle;
wherein the first image including the outside view is transmitted from the first processing unit to the third processing unit directly or transmitted from the first processing unit to the second processing unit and then transmitted from the second processing unit to the third processing unit.

16. A method of operating a communication and image projection system in a vehicle in a fleet, the communication and image projection system includes an image sensor unit, a processing unit and a projection unit, the method comprising:
receiving an outside image captured by an outside vehicle in the fleet; and
projecting the outside image to a surface viewable by an occupant of the vehicle.

17. The method of claim 16, further comprising:
capturing images surrounding the vehicle by the image sensor unit; and
processing the image by the processing unit and transmitting the image to another vehicle.

18. The method of claim 17, further comprising:
determining a position of the vehicle;
identifying an image including an outside view; and
transmitting the image including the outside view to the another vehicle.

19. The method of claim 17, wherein the surface viewable by the occupant of the vehicle is a window of the vehicle, or an external surface of an adjacent vehicle

20. The method of claim 17, wherein the processing unit is communicated with processing units of other vehicles in the fleet via a dedicated short range communication or a wifi or a cloud server.
